(19) United States
(12) Patent Application Publication
(10) Pub. No.: US 2004/0107627 A1
(43) Pub. Date: Jun. 10, 2004

(54) Spinning bait/lure with horizontal cylinder and drum

(76) Inventor: Eugene Patrick Rodely, Du Quoin, IL (US)

Correspondence Address: Eugene P. Rodely, 156 U.S. Route 51, Du Quoin, IL, 62832, US

(21) Appl. No.: 10/439,431

(22) Filed: May 16, 2003

Related U.S. Application Data
(60) Provisional application No. 60/383,248, filed on May 23, 2002.

(51) Int. Cl. A01K 85/00

(52) U.S. Cl. 43/42.19

(57) ABSTRACT

A fishing lure of the spinning type for use especially to attract the category of fish known as Bass, this lure may also work on some other species of fresh, and saltwater fish. The invention includes an upwardly and rearward legs of a wire skeleton with a spinning blade, rotateably mounted to a upper leg with a rearwardly extending leg terminating with a weighted head or body molded around a hook. A modified form of the invention utilizes the spinning action of the blade to affect the horizontal-drumming device mounted just ahead of the blade, on the upper leg.

### BACKGROUND AND SUMMARY

This invention relates generally to the spinning type lure with a metal blade with a weighted body molded on a hook in said body.

Spinning lures are and have been a means which many anglers use to attract fish. The lure body and spinning blade are usually connected by a wire type skeleton which has a swivel connection that will permit the metal blade to spin when pulled through the water.

The present invention is also the spinner type, which is constructed to produce a drumming noise to attract fish. This invention uses a conventional spinning type lure but has a distinct specialty. The drum is mounted to the spinning lure frame with a cylinder. This cylinder is mounted horizontally on the frame by using and insertion into the cylinder, both forward and rearward to effectively hold the cylinder on the frame. The drumming device is then inserted into the hole in the cylinder setting on the frame horizontally to cause the noise to attract fish.

### DESCRIPTION OF THE DRAWINGS

FIG. 1 is a side view of the spinning lure/bait and shows the mounting of the cylinder to the wire frame.

FIG. 2 is a top view of the lure and shows how the cylinder is mounted to the wire frame horizontally.

FIG. 3 is a perspective view of the spinning lure/bait with cylinder and drum, and how the cylinder is mounted on the frame horizontally, and where the drum will be placed and sealed.

FIG. 4 is a top view of the cylinder with the drum.

FIG. 5 is an end or top view of the cylinder alone.

FIG. 6 is a side view of the cylinder.

FIG. 7 is a cut away side view of the drumming device.

FIG. 8 is an end or top view of the drumming device.

FIG. 9 is a side view of the cylinder made into a self-contained drumming device.

FIG. 10 is the side, end, and top view of the metal stops used to make the drum.

FIG. 11 is a perspective view of the spinning lure/bait with cylinder and drum, and how the cylinder is mounted on the frame horizontally, and how the metal caps and steal ball will be placed in the cylinder to create the drum.

### DESCRIPTION OF THE EMBODIMENTS

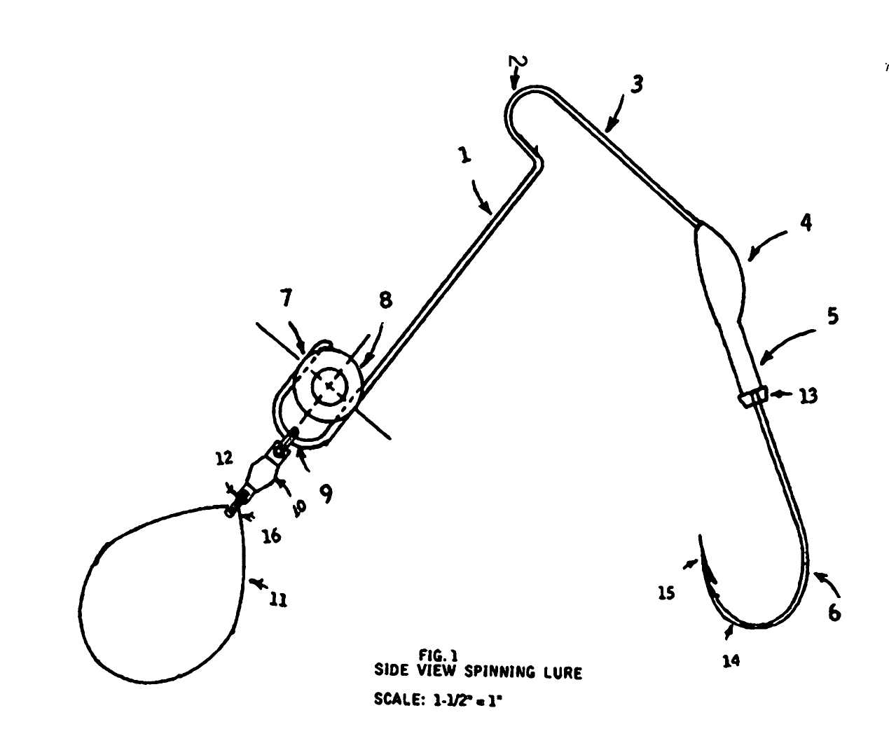

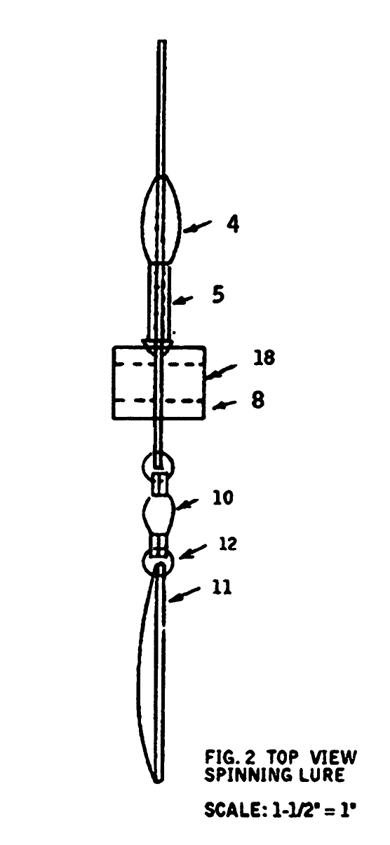

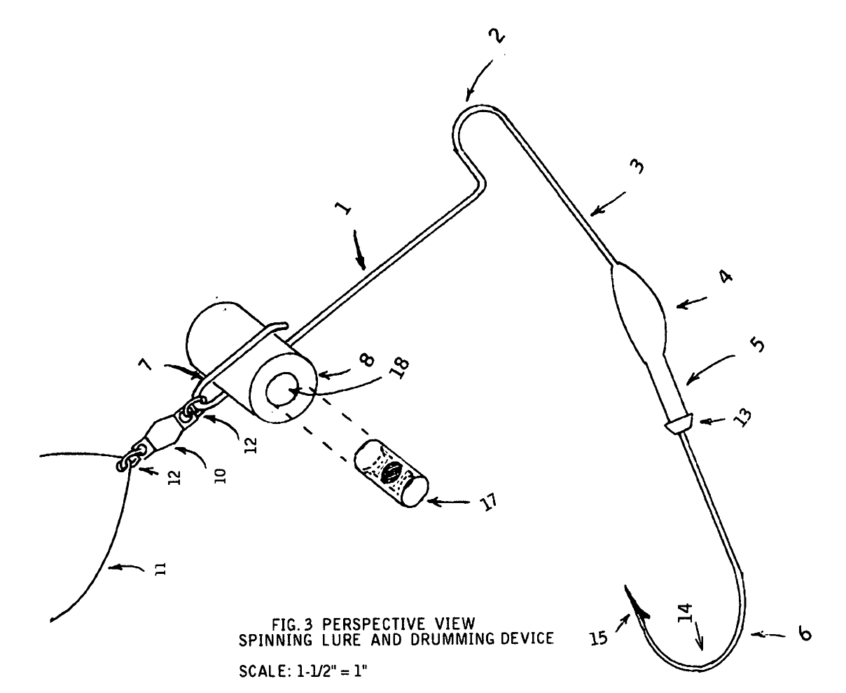

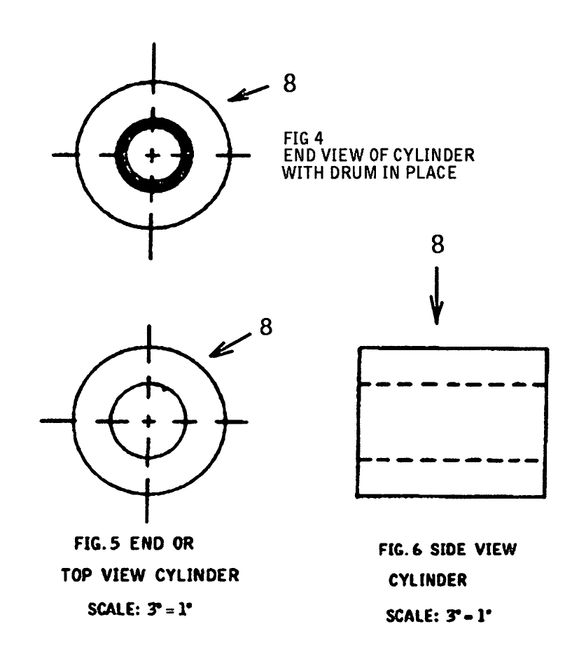

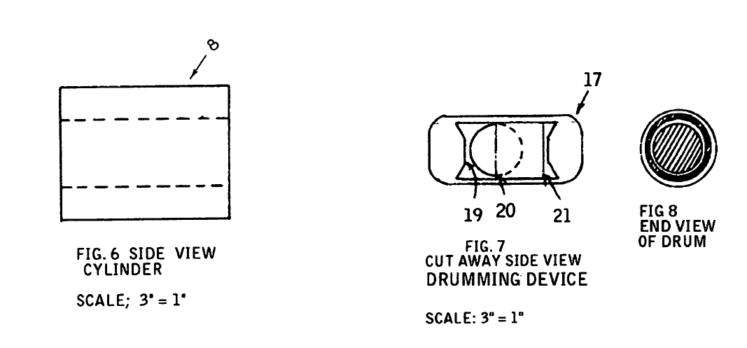

Describing this invention by going through the numerals on each illustration should give the details needed for the patent. FIG. 1 the lure is indicated by the numeral 1 and also is the upward leg. Numeral 2 is the bend and the place of attachment for the fishing line. 3 is the rearward leg going to the molded body 4, of which 5 is a part of the molded body for the purpose of holding a rubber skirt in place, and 13 is the stop to prevent the skirt from coming off. A hook 6 is attached the wire skeleton and then molded into the body. 14 is the curve in the hook shank of which 15 is the point and barb. On the upward leg 7 is the top of the upward leg that is bent, embedded into and sealed in the cylinder both on the upward and lower part of the cylinder. 8 is the cylinder of which 7 is attached. 9 is the bend in the upward leg after it is sealed on the lower side of the cylinder. The bend in the upward leg can be bent up and back or bent down and back to hold cylinder 8 in place. This bend 9 is used to attach the swivel 10 to the lure of which 12 is a ring to attach both the lure 1, swivel 10 and the spinning blade 11, 16 is the hole in the blade 11. FIG. 3 shows all of the above. In addition, blade 11 causes the rhythmic motion of the ball 20 in FIG. 7 to move back and forth hitting the ends 19 of the drum 17 making a loud constant noise while being retrieved through the water. The purpose of the drum 17 is to make a much different sound than the rattle, that so many other lure inventors use on their inventions. The sound has a much more constant booming noise, instead of a sporadic sound coming from the lure.

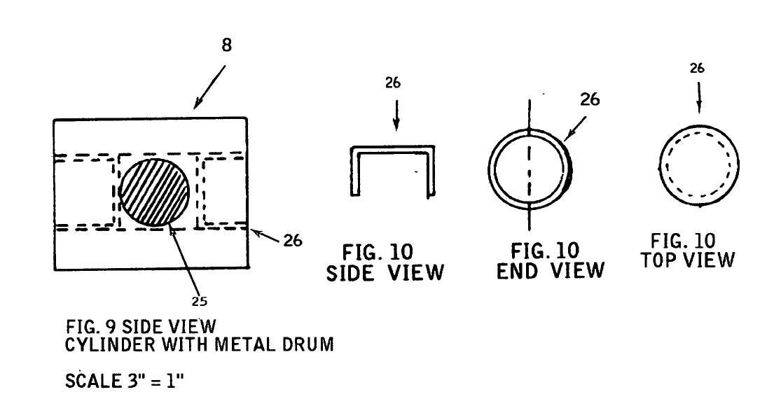

Looking at FIG. 3 it is easy to see how the cylinder 8 is mounted horizontally on the upward leg 1. The hole 18 has been designated for the drum 17. Once the drum is inserted into the cylinder hole 18 and sealed with an adhesive, the ring 12 and swivel 10 and blade 11 can be added to the lure. The cylinder 8 and the drum 17 have to work together as a complete unit, which are mounted horizontally. Although the cylinder can be made into a drumming device, and this can be accomplished as shown in FIGS. 9, 10 and 11.

In FIG., 11 one can see how cap 26 along with ball 25 are inserted into cylinder 8. Ball 25 is inserted into the cylinder 8 between the two caps 26. Upon the insertion of the caps, 26 into hole 18 of cylinder 8, and the ball 25 placed between caps 26. An adhesive is applied to the caps 26 upon insertion into cylinder 8 and hole 18 so a seal will be formed between the caps 26 and cylinder 8. Placing ball 25 between metal caps 26, which are inserted in each end of the cylinder 8, creates the drum.

What is being claimed as being new and desired of protection by the Letters of Patent of the United STATES, are as follows.

1. A fishing lure which will be comprised of a wire skeleton body, including an eye for attachment to the line. This eye or loop will be in the middle between the upwardly and rearwardly extended legs. This wire skeleton is of one piece of wire bent to give the loop or eye between the upward and regressive legs. The upward leg will extend from said loop to the cylinder, which houses the drum and will be mounted diversely around the cylinder and drum as to make the cylinder set horizontal at the end of the upward leg.

2. This cylindrical piece will house the drum, and will be transversed by the upward leg of the wire frame, and there by be fixed in a horizontal manner and not in vertical manner as does the rattle in U.S. Pat. No. 5,024,019 showing distinct difference in the two inventions. The difference being not only the design, but also the way in which a noise is being made by the device on the spinning lure/bait:
It would be intrusive to say that because I would have invented a (can opener) that my invention and patent rights would be able to cover all improvements and new developments to said (can opener). Just because I have stated, that all such improvements would be covered in my patent application.

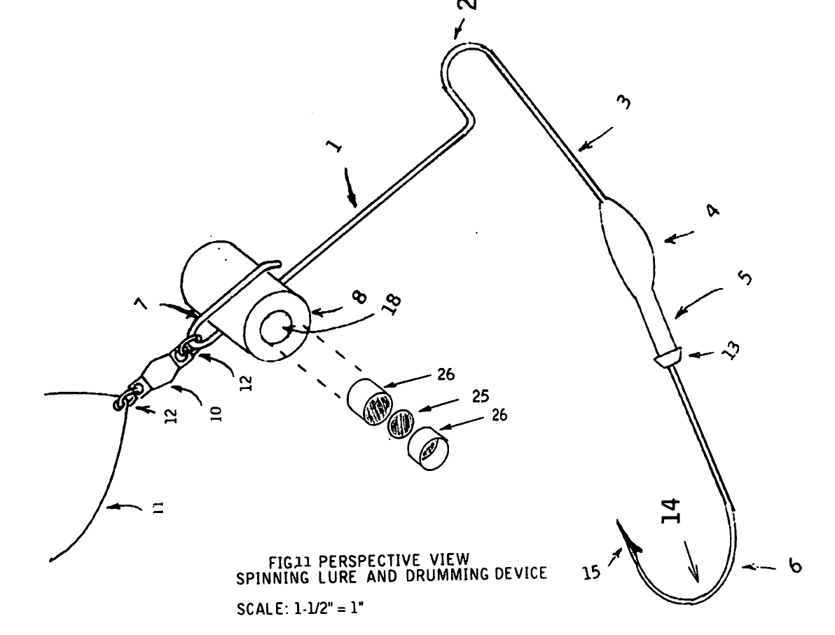

3. The cylinder is to hold the drum and is itself not the noise-making device, but can be made into a drumming device as show on drawings (FIGS. 9 and 10). The cylinder works in conjunction together to make this invention work correctly. The cylinder is a new means by which the rattle or drum can be mounted to the spinning lure. The cylinder is connect to the upward leg of the wire frame or skeleton by the intersection of both the aloft and regressive sides of the cylinder. The cylinder is held in place by means of an adhesive. The drum is placed inside the cylinder and sealed by means of some type of adhesive.

4. The cylinder however can be made into a drum or a rattle. This is done without the placement of a drum inside the cylinder. This is accomplished by placing two metal stops at each end in the cylinder and a metal ball between the two metal stops and sealing the two metal stops at each end of the cylinder.

5. The cylinder with the two metal stops will create the drumming noise and will not be necessary to put a drumming device in the cylinder. The cylinder will now be the drum.

6. From all of the research and inquires made by myself there is not, nor has there ever been a noise making device mounted on a spinning lure/bait horizontally.
The fishing lure or spinning bait is comprised of a metal frame or skeleton which also has on the regressive leg a molded body or head around an attached hook. The hook attaches to the leg by bending the metal frame through the eye of the hook. Then the molded lead or other material is formed around the end of the frame and eye of the hook.
